(19) United States
(12) Patent Application Publication
(10) Pub. No.: US 2013/0009522 A1
(43) Pub. Date: Jan. 10, 2013

(54) DRIVE MOTOR FOR ELECTRIC VEHICLE

(75) Inventors: Takayoshi OZAKI, Iwata-shi (JP); Yusuke Makino, Iwata-shi (JP); Koichi Okada, Iwata-shi (JP)

(73) Assignee: NTN CORPORATION, Osaka (JP)

(21) Appl. No.: 13/599,060

(22) Filed: Aug. 30, 2012

Related U.S. Application Data
(63) Continuation of application No. PCT/JP2011/054601, filed on Mar. 1, 2010.

(30) Foreign Application Priority Data
Mar. 4, 2010 (JP) 2010-047792

(51) Int. Cl. H02K 7/14

(52) U.S. Cl. 310/67 R

(57) ABSTRACT

A drive motor for an electrically powered automotive vehicle is provided which includes a motor stator including a magnetic body and coils. The inner peripheral surface of the magnetic body has a plurality of teeth protruding therefrom, around which the coils are wound. The drive motor also includes a motor housing mounted to an outer periphery of the motor stator to retain the motor stator. The outer peripheral surface of the magnetic body includes cutout portion(s) formed at circumferential location(s) thereof, with the circumferential location(s) being at the same phase as those of the teeth. An inner peripheral surface of the motor housing includes engagement portion(s) formed at circumferential location(s) thereof, with the circumferential location(s) being opposed to the cutout portion(s). The engagement portion(s) is/are engageable with the cutout portion(s). The engagement portion(s) and the cutout portion(s) cooperate with each other to form arresting unit(s) for arresting the motor stator.

### CROSS REFERENCE TO THE RELATED APPLICATION

This application is a continuation application, under 35 U.S.C. §111(a), of international application No. PCT/JP2011/054601, filed Mar. 1, 2011, which claims priority to Japanese patent application No. 2010-047792, filed Mar. 4, 2010, the entire disclosure of which is herein incorporated by reference as a part of this application.

### BACKGROUND OF THE INVENTION

1. Field of the Invention

The present invention relates to a drive motor for an electrically powered automotive vehicle, which may be used as an electric in-wheel motor built in a wheel of the automotive vehicle.

2. Description of Related Art

If a vehicle drive motor and/or a controller for controlling the vehicle drive motor, both employed in the electrically powered automotive vehicle, or electric vehicle for short, fail to operate, the outcome would be a fatal situation that takes place. In the drive motor for the electric vehicle, in order to maximize the efficiency, the timing at which an electric current is delivered to each coil wound across the motor stator is controlled, based on the angle between the rotor and stator. An angle sensor, such as a resolver, that can perform angle sensing with a high resolution may be used for measurement of such an angle.

### PRIOR ART LITERATURE

[Patent Document 1] JP Laid-open Patent Publication No. 2009-262616
[Patent Document 2] JP Laid-open Patent Publication No. 2008-168790

A drive motor for an electrically powered automotive vehicle, during the travel of the vehicle, has to operate in a severe environment—that is, an environment in which the motor is constantly subject to externally exerted vibrations. If, by any chance, a misalignment of the fixing position of the motor stator occurs relative to the position of an angle sensor due to vibrations in such a sever environment, the timing at which an electric current is delivered to each coil wound across the motor stator can no longer be controlled correctly. This may lower the efficiency of the motor. In particular, when a drive motor for an electrically powered automotive vehicle is configured to transmit an output to a tire through a reduction gear unit having a high reduction gear ratio, an unstable angle measurement by an angle sensor may result in a change in torque of the motor being amplified and then transmitted to the tire. Hence, the reliability of a motor controller is important.

Also, a large output of a drive motor for an electrically powered automotive vehicle, which is typically no less than 10 kW, implies a correspondingly large loss in a motor due to the heat generated. Therefore, how to cool a drive motor is one of the concerns here. A reduction gear unit having a high reduction gear ratio such as the one discussed above enables the use of smaller motor, thereby allowing for a smaller design of a motor system as a whole. However, the loss in a motor does not change with smaller design of the motor. In other words, although a drive motor having a smaller motor volume can be used in conjunction with a reduction gear unit having a high reduction gear ratio, the heat generated by such a motor (i.e. a larger loss in the motor) relative to its volume will show an increase. In this case, the cooling of the drive motor becomes all the more important.

### SUMMARY OF THE INVENTION

An object of the present invention is to provide a drive motor for an electrically powered automotive vehicle, which can, without the need to increase an outer diameter dimension thereof, prevent misalignment of a motor stator that may be caused by vibrations, thereby, in turn, preventing reduction in efficiency of the motor that may be caused by misalignment.

Another object of the present invention is to provide a drive motor for an electrically powered automotive vehicle, which can be cooled, without the need to increase an outer diameter dimension.

The present invention provides a drive motor for an electrically powered automotive vehicle. The drive motor includes a motor stator including a magnetic body and coils, with the magnetic body having inner and outer peripheral surfaces. The outer peripheral surface has a round shape in section, and the inner peripheral surface has a plurality of teeth protruding therefrom. The coils are wound around the teeth. The drive motor also includes a motor housing mounted to an outer periphery of the motor stator to retain the motor stator. The outer peripheral surface of the magnetic body includes cutout portion(s) formed at circumferential location(s) thereof, with the circumferential location(s) being at the same phase(s) as those of the teeth. An inner peripheral surface of the motor housing includes engagement portion(s) formed at circumferential location(s) thereof, with the circumferential location(s) being opposed to the cutout portion(s). The engagement portion(s) is/are engageable with the cutout portion(s). The engagement portion(s) and the cutout portion(s) cooperate with each other to form arresting unit(s) for arresting the motor stator.

According to this construction, cutout portion(s) is/are formed at circumferential location(s) of the outer peripheral surface of the magnetic body, with the circumferential location(s) being at the same phase(s) as those of the teeth, and engagement portion(s) is/are formed at circumferential location(s) of an inner peripheral surface of the motor housing, with the circumferential location(s) being opposed to the cutout portion(s). Moreover, the engagement portion(s) and the cutout portion(s) cooperate with each other to form arresting unit(s) for arresting the rotation of the motor stator. This prevents possible misalignment of the fixing position of the motor stator relative to an angle sensor that detects the angle between the motor stator and the motor rotor. In this way, an unstable detection by an angle sensor due to such a misalignment which, in turn, causes deviation in the timing at which an electric current is delivered to each coil can be prevented. Furthermore, an undesirable variance in output torque that may be caused by such deviation in the timing can also be prevented, thereby maintaining a maximum motor efficiency. It is to be noted that the aforementioned circumferential location(s) of the outer periphery of the magnetic body of the motor stator, which are located at the same phase(s) as those of the teeth, have/has lower magnetic flux density to create a drive force for the motor. Therefore, the formation of the cutout portion(s) at such circumferential location(s) of the surface of the outer periphery will have little effect on the driving of the motor. Furthermore, such a configuration of forming cutout portion(s) at circumferential location(s) of the outer peripheral surface of the motor stator does not require increase in the outer diameter of the motor housing. In this way, a motor can be provided which can, without the need to increase an outer diameter dimension thereof, prevent misalignment of a motor stator that may be caused by vibrations, thereby, in turn, preventing reduction in efficiency of the motor that may be caused by misalignment.

In the present invention, the cutout portion(s) of the motor stator may have the shape(s) of a flat surface cut in part of the outer peripheral surface of the magnetic body and the engagement portion(s) of the motor housing may have flat surface(s) matching with the cutout portion(s) having the flat surface. In other words, a cylindrical surface defining the outer peripheral surface of the magnetic body may have a cross sectional shape including flat surface(s) cut therein, with the flat surface(s) each representing a chord of an arc of the cylindrical surface. Such a configuration of the cutout portion(s) of the motor stator having the shape(s) of a flat surface can prevent reduction in strength of the motor stator due to the formation of cutout portion(s). Also, in the present invention, the cutout portion(s) of the motor stator may be axially extending recess portion(s) in the form of groove(s) that is/are radially inwardly depressed and the engagement portion(s) of the motor housing may be axially extending projection portion(s) that is/are radially inwardly projected. Such a construction of recess portion(s) in the form of groove(s) and projection portion(s) being engageable with each other can enhance the reliability of the aforementioned arresting effect.

In the present invention, the motor stator may include a plurality of the cutout portions. The plurality of the cutout portions may include cutout portion(s) in engagement with the engagement portion(s) of the inner peripheral surface of the motor housing, and the other cutout portion(s) not in engagement with the engagement portion may form a cooling liquid passage. Such a configuration of employing the cutout portions of the stator motor partially as a cooling liquid passage allows for the cooling of the motor stator, without the need to increase an outer diameter dimension of the motor. Since the cutout portion(s) for forming the arresting unit(s) and the cutout portion(s) for forming the liquid passage can be all processed in the same fashion, an increased productivity can be achieved. Also, such a configuration of providing both cutout portion(s) for forming the arresting unit(s) and the cutout portion(s) for forming the liquid passage means a circumferentially distributed arrangement of cutout portions; in other words, a group of portions with changed magnetic resistance and a group of portions with changed strength, both of which are created due to the formation of the cutout portions, are circumferentially arranged in such a way that each of these groups of portions achieves a good balance among them along a circumference.

In the present invention, the drive motor may be an in-wheel motor of a type incorporated in a wheel. With this drive motor, since the provision of the detention or arresting unit(s) for arresting the motor stator from rotating makes it possible to avoid the increase of the outer diametric dimension of the motor, it can readily be accommodated within a diameter defined by an inner periphery of the wheel, even when the drive motor is used as the in-wheel motor.

In the present invention, an output of the drive motor may be transmitted to a wheel through a reduction gear unit. Where the output of the motor is transmitted to the vehicle wheel through the reduction gear unit as described above, if the fixing position of the motor stator displaces relative to an angle sensor, a change of the torque of the motor resulting therefrom is amplified and then transmitted to the vehicle wheel. Even in this case, since the drive motor is provided with the detention or arresting unit(s) for arresting the motor stator from rotating and the change in torque resulting from the displacement in position of the motor stator is avoided, it is possible to avoid the possibility that the change in torque may, after having been amplified, be transmitted to the vehicle wheel through the reduction gear unit.

In the present invention, the reduction gear unit may be in the form of a cycloidal gear device. Alhough the cycloidal gear unit has a high reduction gear ratio, thereby allowing for compactization of the drive motor, a loss in the motor will not change by such compactization. Hence, the heat generated by such a smaller motor (i.e. loss in the motor) relative to its volume will show an increase. Here, by employing the cutout portions of the stator motor partially as a cooling liquid passage, the motor can be cooled more effectively.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal sectional view showing a wheel support bearing assembly having mounted thereon a drive motor for an electrically powered vehicle, which is designed in accordance with a preferred embodiment of the present invention;

FIG. 2 is a cross sectional view taken along the line II-II in FIG. 1, showing a reduction gear unit;

FIG. 3 is a fragmentary sectional view showing on an enlarged scale, an important portion of the reduction gear unit shown in FIG. 2;

FIG. 4 is a cross sectional view taken along the line IV-IV in FIG. 1, showing the drive motor;

FIG. 5 is a view similar to FIG. 2, showing the drive motor designed in accordance with a second preferred embodiment of the present invention;

FIG. 6 is a view similar to FIG. 2, showing the drive motor designed in accordance with a third preferred embodiment of the present invention; and

FIG. 7 is a view similar to FIG. 2, showing the drive motor designed in accordance with a fourth preferred embodiment of the present invention.

### DESCRIPTION OF THE PREFERRED EMBODIMENTS

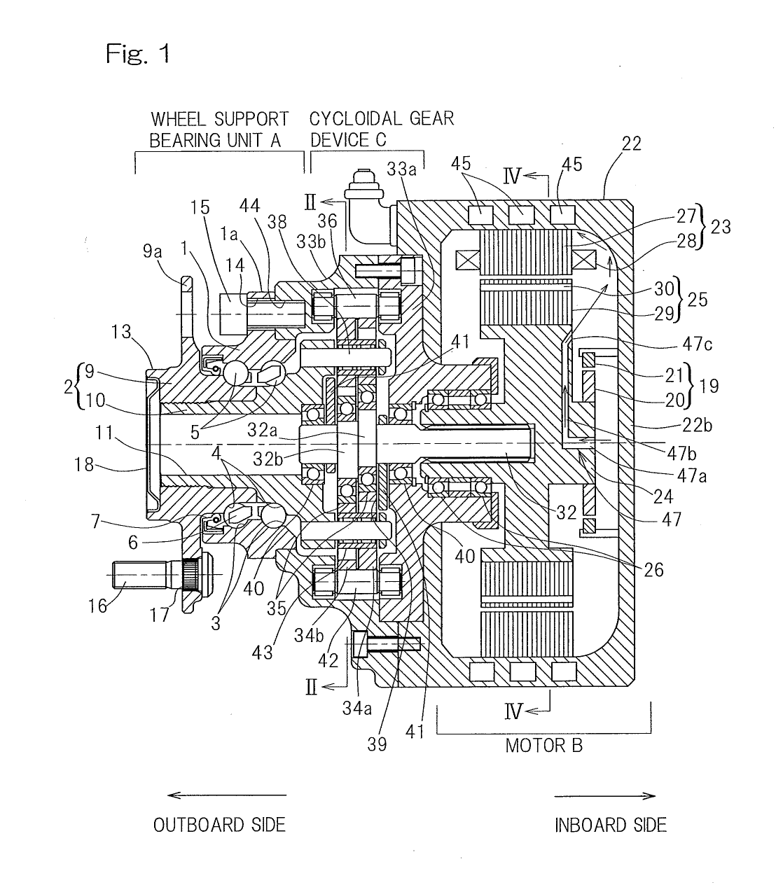

FIGS. 1 to 4 illustrates a first preferred embodiment of the present invention. In particular, FIG. 1 illustrates a longitudinal sectional view of a wheel support bearing assembly incorporating therein a drive motor for an electric vehicle designed in accordance with the first preferred embodiment of the present invention. The wheel support bearing assembly shown therein is a wheel support bearing assembly of an in-wheel motor incorporated type, in which a reduction gear unit C is interposed between a wheel support bearing unit A for the automotive vehicle and the drive motor B according to the first embodiment of the present invention and a hub for a vehicle drive wheel, supported by the wheel support bearing unit A, and an output shaft 24 of the drive motor B are coaxially connected with each other. The reduction gear unit C is a cycloidal gear device of a structure, in which an input shaft 32 drivingly coupled coaxially with the output shaft 24 of the drive motor B is formed with eccentric portions 32a and 32b and curvilinear plates 34a and 34b are mounted respectively on the eccentric portions 32a and 32b through corresponding bearing units 35 so that eccentric motions of those curvilinear plates 34a and 34b can be transmitted as a rotational motion to the wheel support bearing unit A.

It is to be noted that hereinafter in this specification, terms “outboard” and “inboard” represent one side of the vehicle body away from the longitudinal center of the vehicle body and the other side of the vehicle body close to the longitudinal center of the vehicle body, respectively, when assembled in the vehicle body.

The wheel support bearing unit A includes an outer member 1 having an inner periphery formed with a plurality of rows of rolling surfaces 3, an inner member 2 having an outer periphery formed with rolling surfaces 4 held in face to face relation to those rolling surfaces 3, and a plurality of rows of rolling elements 5 that are interposed between the rolling surfaces 3 in the outer member 1 and the rolling surfaces 4 in the inner member 2. The inner member 2 concurrently serves as a hub on which the vehicle drive wheel is mounted.

The wheel support bearing unit 4 referred to above is rendered to be a double row angular contact ball bearing, in which the rolling elements 5 are employed in the form of balls that are rollingly retained by a ball retainer 6 employed for each row. The rolling surfaces 3 and 4 referred to above are of an arcuately sectioned configuration and are so formed as to have respective contact angles held in back-to-back relation with each other. An annular bearing space is delimited between the outer member 1 and the inner member 2 positioned inside the outer member 1, and an outboard open end of the annular bearing space so delimited is sealed by a sealing member 7.

The outer member 1 is of a kind that is rendered to be a stationary raceway ring and is also rendered to be of one piece construction having a flange 1a to be fitted to a housing 33b on the outboard side of the reduction gear unit C. This flange 1a has a bolt insertion hole 14 defined at a plurality of circumferential locations thereof. Also, the housing 33b is provided with a bolt threading hole 44, having an inner periphery helically threaded, at locations alignable with the bolt insertion holes 14. When a mounting bolt 15 inserted through the bolt insertion hole 14 is threadingly engaged in the bolt threading hole 44, the outer member 1 is fitted to the housing 33b.

The inner member 2 is of a kind that is rendered to be a rotatable raceway ring and includes an outboard member 9 having a hub flange 9a for the support of an automotive wheel and an inboard member 10 having an outboard side, mounted on an inner periphery of the outboard member 9, and integrated together with the outboard member 9 by means of crimping. The rolling surfaces 4 of each row are formed in the outboard member 9 and the inboard member 10, respectively.

The inboard member 10 has its center provided with a center bore 11. The hub flange 9a is provided with a press fitting hole 17 at a plurality of circumferential locations for receiving therein a corresponding hub bolt 16. A cylindrical pilot portion 13 for guiding a wheel and a brake component (both not shown) is defined in the vicinity of a root portion of the hub flange 9a in the outboard member 9 so as to protrude towards the outboard side. This pilot portion 13 has an inner periphery to which a cap 18 is fitted for closing an outboard opening of the center bore 11.

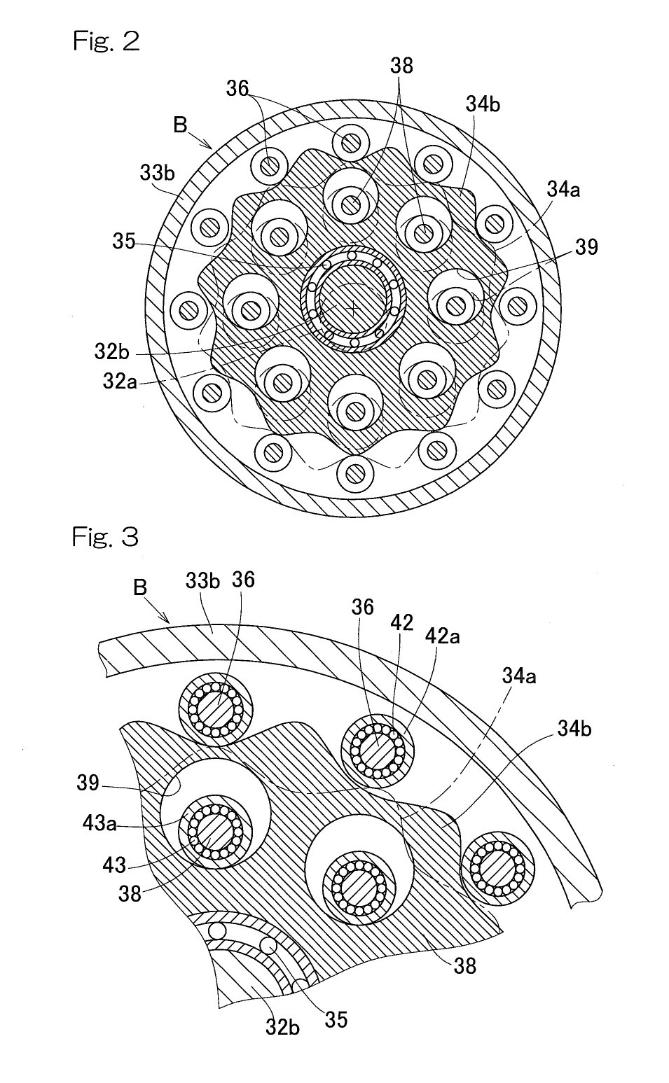

The reduction gear unit C is a cycloidal gear device as hereinabove described, and the two curvilinear plates 34a and 34b, each being of a contour depicted by the smoothly corrugated trochoidal curve as shown in FIG. 2, are mounted on the respective eccentric portions 32a and 32b of the input shaft 32 through the respective bearings 35. Each of the curvilinear plates 34a and 34b may be that depicted by the cycloidal curve. In any event, the term “cycloidal gear device” referred hereinbefore and hereinafter referred to in this specification is to be understood as encompassing both a reduction gear device having a contour depicted by a cycloidal curve and a reduction gear device having a contour depicted by a trochoidal curve.

A plurality of outer pins 36 for guiding the respective eccentric motions of the curvilinear plates 34a and 34b on an outer peripheral side are fitted at their opposite ends to the housing 33b, and a plurality of inner pins 38 fitted to the inboard member 10 of the inner member 2 are engaged having been inserted in a corresponding number of round sectioned throughholes 39 defined inside each of the curvilinear plates 34a and 34b. The input shaft 32 referred to above is fitted by spline to the output shaft 24 of the drive motor B and is therefore rotatable together with the latter. The input shaft 32 referred to above is rotatably supported by the inboard side housing 33a and an inner diametric surface of the inboard member 10 of the inner member 2 through axially spaced two bearing units 40.

As the output shaft 24 of the drive motor B rotates, the curvilinear plates 34a and 34b mounted on the input shaft 32 that is integrally rotatable together therewith undergo respective eccentric motions. These eccentric motions of the curvilinear plates 34a and 34b are transmitted as a rotational motion to the inner member 2 by engaging of the inner pins 38 and the throughholes 39. The rotation of the inner member 2 becomes reduced in speed relative to the rotation of the output shaft 24. By way of example, the one step cycloidal gear device is effective to provide the reduction gear ratio of 10 or higher.

The two curvilinear plates 34a and 34b are mounted on the eccentric portions 32a and 32b of the input shaft 32, respectively, having been offset 180° in phase relative to each other so that those eccentric motions can be counterbalanced with each other, while a counterweight 41 is mounted on both sides of each of the eccentric portions 32a and 32b and is displaced in a direction counter to the direction of eccentricity of the associated eccentric portion 32a and 32b so that vibrations induced by the eccentric motion of each of the curvilinear plates 34a and 34b can be counterbalanced.

As shown on an enlarged scale in FIG. 3, the outer pins 36 have respective bearing units 42 mounted thereon and the inner pins 38 similar have respective bearing units 43 mounted thereon, and those bearing units 42 and 43 includes outer rings 42a and 43a that are held in rolling contact with the outer peripheries of the curvilinear plates 34a and 34b and inner peripheries of the throughholes 39, respectively. Accordingly, the respective eccentric motions of the curvilinear plates 34a and 34b can be smoothly transmitted as the rotational motion to the inner member 2 while the resistance of contact between the outer pins 36 and the outer peripheries of the curvilinear plates 34a and 34b and the resistance of contact between the inner pins 38 and the inner peripheries of the throughholes 39 are reduced.

The drive motor B is of a radial gap type, in which a radial gap is provided between a motor stator 23, fixed to the cylindrical motor housing 22, and a motor rotor 25 fitted to the output shaft 24. The output shaft 24 is supported in a cantilever fashion by a cylindrical portion of the housing 33a on the inboard side of the reduction gear unit C through two, axially spaced bearing units 26. Also, a peripheral wall portion of the motor housing 22 is provided with a cooling liquid passage 45. With a lubricant oil or a water soluble cooling agent flowing through this cooling liquid passage 45, cooling of the motor stator 23 takes place.

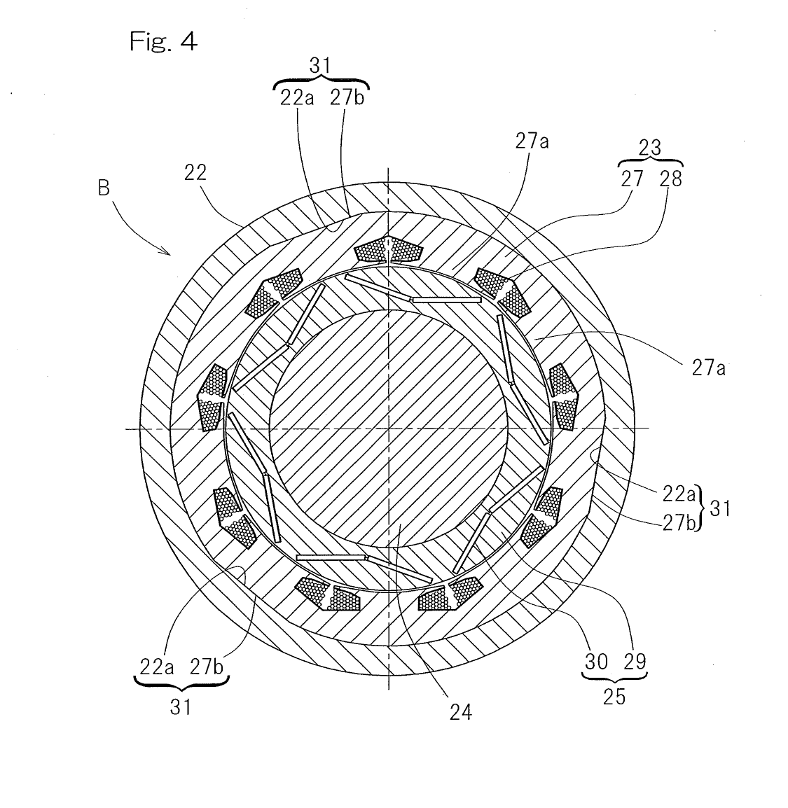

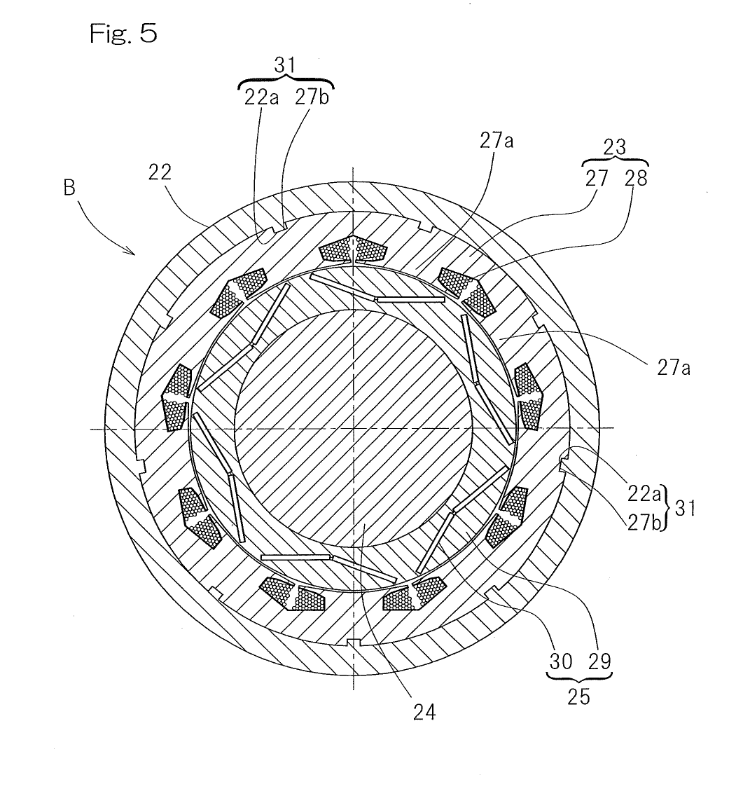

As shown in FIG. 4 in a cross sectional view taken along the line IV-IV in FIG. 1, the motor stator 23 includes a stator core portion 27, made of a soft magnetic material, and coils 28. The stator core portion 27 is of a ring shape, in which an outer peripheral surface thereof has a round shape in section, and a plurality of teeth 27a each protruding radially towards an inner diametric side are formed in an inner peripheral surface of the stator core portion 27 so as to assume respective teeth spaced in a circumferential direction. Each of the coils 28 is wound around the corresponding tooth 27a of the stator core portion 27. The stator core portion 27 has its outer peripheral surface mounted on an inner peripheral surface of the motor housing 22 and is therefore retained by the motor housing 22.

As shown in FIG. 4, an outer peripheral surface of the stator core portion 27 includes cutout portions 27b formed at circumferential locations thereof (in the illustrated example, three circumferential locations), with the circumferential location being at the same phase as those of the teeth 27a. The motor housing 22, which retains the stator core portion 27, has an inner peripheral surface that includes engagement portions 22a formed at circumferential locations thereof, with the circumferential locations being opposed to the cutout portions 27b and the engagement portion being engageable with the cutout portions 27b. The cutout portions 27b of the stator core portion 27 and the engagement portion 22a of the motor housing 22 cooperate with each other to form detention or arresting unit(s) 31 by which the motor stator 23 is incapable of rotationally displacing relative to themotor housing 22. In the illustrated example, the cutout portions 27b of the stator core portion 27 are each shaped to have a flat surface cut in part of the outer peripheral surface of the stator core portion 27. The engagement portions 22a of the motor housing 22 are each shaped to have a flat surface that follows the flat surface of the corresponding cutout portion 27b. It is to be noted that the aforementioned circumferential locations of the outer periphery of the stator core portion 27, which are located at the same phases as those of the teeth 27a, have lower magnetic flux density to create a drive force for the motor B. Therefore, the formation of the cutout portions 27b at such circumferential locations of the surface of the outer periphery has little effect on the driving of the motor.

The motor rotor 25 includes a rotor core portion 29 of a ring shape adapted to be disposed on the output shaft 24 in coaxial relation with the motor stator 23, and a plurality of permanent magnets 30 built or embedded in the rotor core portion 29. The permanent magnets 30 are circumferentially distributed in the rotor core portion 29 at substantially equal intervals therebetween.

As shown in FIG. 1, the drive motor B is provided with an angle sensor 19 for detecting the rotational phase of the motor rotor 25. This angle sensor 19 is made up of a to-be-detected member 20, provided on the outer peripheral surface of the output shaft 24, and a detecting member 21 provided in the motor housing 22 in face to face relation with and proximate to the to-be-detected member 20 in, for example, a radial direction. For this angle sensor 19, a resolver, for example, is employed. In this drive motor B, in order to maximize the efficiency thereof, the timing at which an electric current is delivered to each coil 28 of the motor stator 23 is controlled by a motor controller (not shown) on the basis of the rotational phase of the motor rotor 25 detected by the angle sensor 19.

As has been discussed above, in a drive motor B for an electrically powered automotive vehicle, according to the aforementioned configuration(s) or construction(s), cutout portion(s) 27b is/are formed at circumferential location(s) of an outer peripheral surface of a stator core portion 27, with the stator core portion 27 being in the form of a magnetic body and one of the components of a motor stator 23. The circumferential location(s) at which the cutout portion(s) 27b are formed are at the same phase(s) as those of teeth 27a. Also, a motor housing 22 has an inner peripheral surface that includes engagement portion(s) 22a formed at circumferential location(s) thereof, with the circumferential location(s) being opposed to the cutout portion(s) 27b. The engagement portion(s) 22a is/are engageable with the cutout portion(s) 27b. And the engagement portion(s) 22b and the cutout portion(s) 27b cooperate with each other to form detention or arresting unit(s) 31 for arresting the rotation of the motor stator 23. Such a configuration of cutout portion(s) being formed in an outer peripheral surface of the motor stator 23 eliminates the need to increase an outer diameter of the motor housing 22. In other words, arresting of the motor stator 23 from rotating is possible without the need to increase an outer diameter dimension of the motor. This prevents a possible misalignment of the fixing position of the motor stator 23 relative to an angle sensor 19 due to vibrations, even when the motor is employed as an in-wheel motor such as shown in FIG. 1 that operates in a severe environment. In this way, an unstable detection by an angle sensor 19 due to such a misalignment which, in turn, causes deviation in the timing at which an electric current is delivered to each coil 28 can be prevented. Furthermore, an undesirable variance in output torque that may be caused by such deviation in the timing at which an electric current is delivered to each coil 28 can also be prevented, thereby maintaining a maximum motor efficiency.

In particular, where as is the case with the wheel support bearing assembly shown in FIG. 1, the output of the drive motor B is transmitted to the drive wheel through the reduction gear unit C having a high reduction gear ratio, the change in torque in the drive motor B is, after having been amplified, transmitted to the vehicle drive wheel, but since the change in output torque in the drive motor B can be avoided as hereinbefore described, the occurrence of the torque change in the vehicle drive wheel can be avoided. Also, even the provision of the detention or arresting unit(s) 31 for arresting the rotation of the motor stator 23 in the drive motor B will not result in the increase of the motor outer diametric dimension and, therefore, even if it is used as an in-wheel motor such as shown in FIG. 1, it can be snugly and neatly accommodated within the vehicle wheel.

FIG. 5 illustrates a second preferred embodiment of the present invention. The drive motor B for the electric vehicle is similar to that shown in and described with reference to FIGS. 1 to 4 in connection with the first preferred embodiment of the present invention, but differs therefrom in that the cutout portions 27b formed in the outer peripheral surface of the stator core portion 27 of the motor stator 23 are axially extending recess portions each in the form of a groove that is radially inwardly depressed and the engagement portions 22a of the motor housing 22 are axially extending projection portions each radially inwardly projected. Also, in this embodiment, the outer peripheral surface of the stator core portion 27 includes cutout portions 27b at all of the circumferential locations that are at the same phases of the teeth 27a. Other functions and effects thereof than those afforded are similar to those of the first embodiment shown in and described with particular reference to FIGS. 1 to 4.

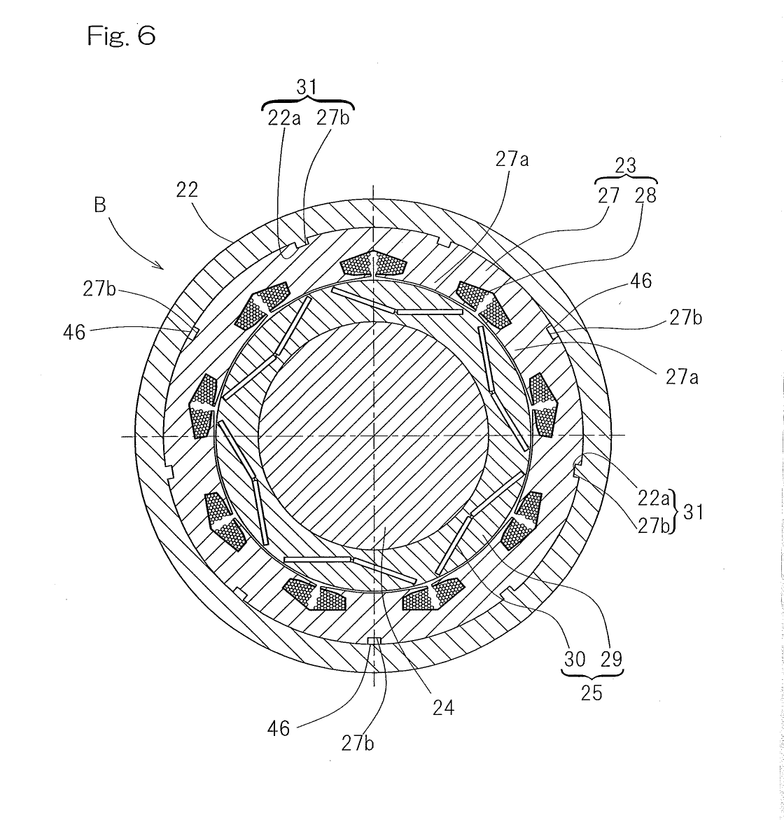

A third preferred embodiment of the present invention is shown in FIG. 6. The drive motor B for the electric vehicle according to this embodiment is similar to that shown in and described with reference to FIG. 5 in connection with the second embodiment of the present invention, but differs therefrom in that the stator core portion 27 includes a plurality of the cutout portions 27b, the plurality of the cutout portions 27b include cutout portion(s) 27b in engagement with the engagement portions 22a of the inner peripheral surface of the motor housing 22, and the other cutout portion(s) not in engagement with the engagement portions 22a form(s) a cooling liquid passage 46.

In the example shown in FIG. 1, an upstream cooling liquid passage 47, which is located at the upstream of the cooling liquid passage 46, is formed in the output shaft 24. The illustrated upstream cooling liquid passage 47 includes first, second and third paths 47a, 47b, 47c. The first path 47a extends from a center of an inboard end of the output shaft 24 towards an outboard side but stops before penetrating to an outboard end. The second path 47b bends at the end of the first path 47a and extends radially outwardly therefrom. The third path 47c bends at the end of the second path 47b and extends radially outwardly in a diagonal fashion towards an inboard end wall 22b of the motor housing 22 to form an opening. For example, an external cooling liquid supply source (not shown), which also supplies a cooling liquid to additional cooling liquid passage(s) 45 formed in a circumferential wall of the motor housing 22, supplies a cooling liquid to the upstream cooling liquid passage 47. As indicated by the arrows in FIG. 1, the cooling liquid delivered to the third path 47c is, by a centrifugal force caused by rotation of the motor rotor 25, injected towards the inboard end wall 22b of the motor housing 22 and flows along the end wall 22b towards the cooling liquid passage 46 of the stator core portion 27.

As has been described, in this embodiment, a plurality of cutout portions 27b formed in the outer peripheral surface of a stator core portion 27 are partially employed as a cooling liquid passage 46. In this way, the motor stator 23 can be cooled, without the need to increase an outer diameter dimension of the motor. Also, in such a configuration as shown in FIG. 1 where a reduction gear unit C having a high reduction gear ratio is employed, compactization of a drive motor B is possible, thus allowing for reduction in size of the motor system as a whole. However, the heat generated by such a smaller motor (i.e. loss in the motor) relative to a volume thereof will show an increase. Here, by providing an additional cooling liquid passage 46 such as in the embodiment under discussion, the drive motor B can be cooled more effectively. Other functions and effects thereof than those afforded are similar to those of the first embodiment shown in and described with particular reference to FIGS. 1 to 4.

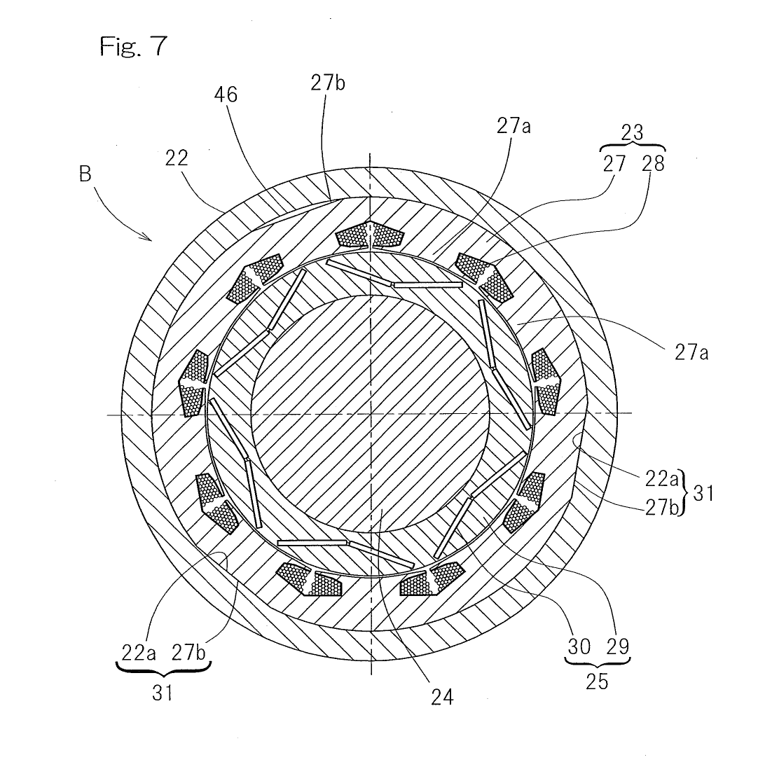

FIG. 7 illustrates a fourth preferred embodiment of the present invention. The drive motor B for the electric vehicle is similar to that shown in and described with reference to FIG. 4 in connection with the first embodiment of the present invention, but differs therefrom in that the stator core portion 27 includes a plurality of the cutout portions 27b each having the shape of a flat surface, the plurality of the cutout portions 27b include cutout portion(s) 27b in engagement with the engagement portions 22a of the inner peripheral surface of the motor housing 22, and the other cutout portion(s) 27b not in engagement with the engagement portions 22a form(s) a cooling liquid passage 46. Other functions and effects thereof than those afforded are similar to those of the third embodiment shown in and described with particular reference to FIG. 6.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

22 . . . Motor housing
22a . . . Engagement portion
23 . . . Motor stator
25 . . . Motor rotor
27 . . . Stator core portion (Magnetic body)
27a . . . Tooth
27b . . . Cutout portion
28 . . . Coil
30 . . . Permanent magnet
31 . . . Arresting unit
46 . . . Cooling liquid passage
B . . . Drive motor
C . . . Reduction gear unit

What is claimed is:

1. A drive motor for an electrically powered automotive vehicle comprises:
a motor stator including a magnetic body and coils, the magnetic body having inner and outer peripheral surfaces, the outer peripheral surface having a round shape in section, the inner peripheral surface having a plurality of teeth protruding therefrom, the coils being wound around the teeth; and
a motor housing mounted to an outer periphery of the motor stator to retain the motor stator;
wherein the outer peripheral surface of the magnetic body includes a cutout portion formed at a circumferential location thereof, the circumferential location being at the same phase as those of the teeth,
wherein an inner peripheral surface of the motor housing includes an engagement portion formed at a circumferential location thereof, the circumferential location being opposed to the cutout portion, the engagement portion being engageable with the cutout portion, and
wherein the engagement portion and the cutout portion cooperate with each other to form an arresting unit for arresting the motor stator.

2. The drive motor for the electrically powered automotive vehicle as claimed in claim 1, wherein the cutout portion of the motor stator has the shape of a flat surface cut in part of the outer peripheral surface of the magnetic body and the engagement portion of the motor housing has a flat surface matching with the cutout portion having the flat surface.

3. The drive motor for the electrically powered automotive vehicle as claimed in claim 1, wherein the cutout portion of the motor stator is an axially extending recess portion in the form of a groove that is radially inwardly depressed and the engagement portion of the motor housing is an axially extending projection portion that is radially inwardly projected.

4. The drive motor for the electrically powered automotive vehicle as claimed in claim 1, wherein the motor stator includes a plurality of the cutout portions, the plurality of the cutout portions include cutout portion(s) in engagement with the engagement portion of the inner peripheral surface of the motor housing, and the other cutout portion(s) not in engagement with the engagement portion form(s) a cooling liquid passage.

5. The drive motor for the electrically powered automotive vehicle as claimed in claim 1, in which the drive motor is an in-wheel motor of a type incorporated in a wheel.

6. The drive motor for the electrically powered automotive vehicle as claimed in claim 1, in which an output of the drive motor is transmitted to a wheel through a reduction gear unit.

7. The drive motor for the electrically powered automotive vehicle as claimed in claim 6, in which the reduction gear unit is in the form of a cycloidal gear device.
